(19) United States
(12) Patent Application Publication
(10) Pub. No.: US 2002/0155279 A1
(43) Pub. Date: Oct. 24, 2002

(54) Method of manufacturing dimensionally stable cellulosic fibre-based composite board and product

(76) Inventors: Chunping Dai, Vancouver (CA); Peter Ens, Burnaby (CA)

Correspondence Address: CHRISTIE, PARKER & HALE, LLP, 350 WEST COLORADO BOULEVARD, SUITE 500, PASADENA, CA, 91105, US

(21) Appl. No.: 09/783,885

(22) Filed: Feb. 14, 2001

(51) Int. Cl. B32B 23/08

(52) U.S. Cl. 428/335; 428/332; 428/481; 428/512; 428/513; 156/311

(57) ABSTRACT

A method for manufacturing a dimensionally stable composite cellulosic product having side and edge surfaces involves applying a sheet of thermoplastic material to at least one side surface of the composite product. Pressure and heat are applied for a pre-determined period via a heated press to melt the thermoplastic material to bond to and coat the at least one side surface of the product. The resulting product enjoys significantly improved dimensionally stability when exposed to water. Thickness swelling of the coated product is reduced by over 70% as compared to a conventional composite cellulosic product without the coating. In the case of oriented strand board (OSB) manufactured according to the method of the present invention, thickness swell of 2-5% after 24 hour water soaking is observed as compared to 10-15% swell with conventional OSB.

### FIELD OF THE INVENTION

This invention relates generally to the field of cellulosic fibre-based composite products, and in particular, to a product that is dimensionally stable with improved resistance to swelling due to moisture and a method for producing the product.

### BACKGROUND OF THE INVENTION

Plywood is manufactured from layers of wood or plies that are cut or peeled from logs. Each layer has a grain, and in the assembled plywood board, adjacent layers having grains running in different directions are stacked and glued together to maximize the strength of the board. Plywood panels have good dimensional stability, that is, they tend to maintain their shape and size when exposed to moisture which makes them the preferred panel for load bearing components in wood frame construction or for panels that will be exposed to the environment. In particular, plywood panels are preferred for flooring and sub-flooring applications.

Plywood panels tend to be more expensive to manufacture in view of higher raw material costs for logs suitable for conversion into plies. In addition, plywood manufacturing process tends to be labour intensive with resulting increased labour costs.

In view of the relatively high cost of plywood panels, alternative less expensive wood based panel products have been developed. In general, these alternative panels are composite products that are manufactured from cellulosic materials such as wood, straw, bark, and hemp in particulate form. The cellulosic particles include chips, strands, flakes or fibres. The particulate cellulosic material is mixed with a bonding agent, such as glue or resin, in a homogenous mass and then pressed and heated at high temperatures and pressures to form structural panels. Oriented strand board (OSB) is an example of such a composite cellulosic panel made from wood strands.

While conventional composite cellulosic panels are equivalent to plywood panels in terms of structural strength and tend to be less expensive, they currently suffer from the drawback that they lack dimensional stability when exposed to humidity or water. In other words, composite cellulosic products tend to increase significantly in thickness and to a lesser degree in length when they become wet. Under normal manufacturing conditions, composite cellulosic products are highly compacted. When exposed to moisture, the product tends to swell and to a greater extent than for the original cellulosic material due to the compaction. For example, the thickness swell for oriented strand board is 10-15% compared to 4-7% for solid wood or a plywood panel of an identical original thickness. Such thickness swell makes composite cellulosic panel products less desirable for certain structural or exposed applications where plywood still dominates.

Considerable efforts have been made in the composite products industry to address the problem of swelling, particularly thickness swelling. Commonly used methods include using greater amounts of resin and wax. Unfortunately, this approach increases the cost of the final product with the result that specially treated composite cellulosic products approach or exceed the cost of plywood panels thereby defeating the purpose of a lower cost alternative to plywood panels.

To reduce the cost of adding additional resins or waxes, heat treating methods have been proposed which involve compacting the cellulosic particles under higher temperatures and for longer periods of time. These solutions have turned out not to be practical as they cause charring or discolouration or a reduction in productivity. Other heat treating methods interfere with the normal production process as they require pre-treatment of the cellulosic material or post-treatment of individual panels in special presses or post-treatment of multiple boards in a conditioning chamber which significantly lowers productivity and raises costs.

Examples of alternative processes known to the applicant include that disclosed in Japanese Kokai Patent Application No. 6-238615. This reference discloses a method for treating woody material to improve dimensional stability. The process can be used with lumber or with composite panels. A special jig for controlling the thickness of the product is provided and the process requires a sealing material about the peripheral edges of the product. Pressing (compacting) and treating are done in a single step which requires major modifications to existing presses. Productivity suffers because the process is carried out on a single panel at a time with a longer pressing time than is conventional.

U.S. Pat. No. 5,028,286 to Hsu discloses a method of making dimensionally stable composite board that involves a steam pre-treatment and then heating and compressing with a hot platen press. In practice, the Hsu method is limited to treating one panel at a time because the required platen heating of panels would take too long if multiple panels were stacked together.

Inoue et al. in the paper “Stabilization of compressed wood using high frequency heating” discloses a treatment method for densifying and stabilizing solid wood (lumber). The process involves pressing and treating a single wood piece at the same time and relies on a special jig that restrains the edges of the wood under treatment. Also, the process requires feeding of cold water into the press platens at the end of the treatment to cool the board before the press opens. This water cooling method cannot be applied to treating multiple large sized boards.

Radcliffe et al. in U.S. Pat. No. 6,136,408 discloses a method for improving dimensional stability of a panel that involves spraying the panel with isocyanate glue and curing the glue by heating. Isocyanate is very expensive and toxic making its use problematic.

U.S. Pat. No. 5,716,563 to Winterowd et al. discloses a post-production process that involves applying glue to the surface of the panel product to form a seal.

Applicant's co-pending U.S. patent application No. 09/415,569 filed Oct. 8, 1999 discloses a method and apparatus for post-production dimensional stabilization of cellulosic fibre-based composite products that relies on high frequency heating and pressure.

### SUMMARY OF THE INVENTION

Applicant has taken a new approach to the problem of creating a cellulosic product with dimensional stability. Prior methods for improving the dimensional stability of a composite cellulosic product tend to use a heat, steam or chemical treatment. Such methods can result in significant negative effects on strength properties of the treated product or require steps that interfere with existing production processes. For these reasons, most of the patented methods discussed above have not been adopted in the industry.

The present invention provides a method and product that relies on a thermoplastic waterproof film being applied to the composite cellulosic material. There are no detrimental effects on the strength properties of the product and the method is easy to implement.

Accordingly, the present invention provides a method for manufacturing a dimensionally stable composite cellulosic product having side and edge surfaces comprising the steps of:

applying a sheet of thermoplastic material to at least one surface of the composite product; and

applying pressure and heat for a pre-determined period to melt the thermoplastic material to bond to and coat the at least one surface of the product.

It is important to note that no synthetic adhesive is required to bond the thermoplastic material to the surface.

In a further aspect, the present invention provides a composite cellulosic product comprising:

a core layer of cellulosic material and bonding agent formed by heating and pressure into a rigid, compressed material having side and edge surfaces;

a layer of thermoplastic material melted and pressed onto at least one of the side surfaces of the core layer to bond to and coat the side surface.

The present invention also provides a method for manufacturing a dimensionally stable composite cellulosic product comprising the steps of:

organizing cellulosic material and a bonding agent into a mat;

applying a sheet of thermoplastic material to at least one surface of the mat; and

applying pressure and heat for a pre-determined period to the mat and thermoplastic material simultaneously to compress and heat the mat into a finished composite cellulosic product having at least one surface bonded to and coated with a thermoplastic material.

In a further aspect, the present invention provides a method for improving the dimensional stability of a composite cellulosic product comprising the step of hot pressing a thermoplastic film over at least one surface of the product to bond to and coat the surface.

In a still further aspect, the present invention provides an improved composite cellulosic product formed from cellulosic material and a bonding agent, the improvement comprising at least one of the surfaces of the product being coated with a sheet of thermoplastic material bonded to the at least one surface by melting and pressing the material to the surface.

The method and product of the present invention relate to a composite cellulosic product that has significantly improved dimensional stability. In particular, thickness swelling of the cellulosic product manufactured according to the process of the present invention is significantly reduced. For example, in the case of oriented strand board (OSB) manufactured according to the method of the present invention, thickness swell of 2-3% after 24 hour water soaking is observed as compared to 10-15% swell with conventional OSB.

A further advantage of the product of the present invention is that the thermoplastic layer or film acts as a barrier between the cellulosic product core and any covering material applied to the product. The thermoplastic layer prevents discolouration of the covering material by preventing the leaching of extractives, such as resin, from the cellulosic composite product.

### BRIEF DESCRIPTION OF THE DRAWINGS

Aspects of the present invention are illustrated, merely by way of example, in the accompanying drawings in which:

FIG. 1 is a schematic view showing a first embodiment of the method of the present invention in which a thermoplastic film layer is applied to both surfaces of a finished composite cellulosic product;

FIG. 2 is a schematic view showing a second embodiment of the method of the present invention in which a thermoplastic film layer is applied to a single surface of a finished composite cellulosic product;

FIG. 3 is a schematic view showing a third embodiment of the method of the present invention in which a thermoplastic film layer is applied to two surfaces of a mat of cellulosic material;

FIG. 4 is a schematic view showing a fourth embodiment of the method of the present invention in which a thermoplastic film layer is applied to a single surface of a mat of cellulosic material; and

FIG. 5 is detailed cross-sectional view through a composite cellulosic product according to the present invention with external thermoplastic coating layers.

### DESCRIPTION OF THE PREFERRED EMBODIMENTS

Referring to FIG. 1, there is shown schematically a first embodiment of the method of the present invention for improving the dimensional stability of composite cellulosic products. The method is carried out on a composite cellulosic product, in the form of a board 8, as the product emerges from the output end 10 of a conventional press 12. Composite cellulosic products include any products formed from cellulosic material, such as wood, straw, bark or hemp. The cellulosic material, generally in the form of particles, such as chips, fibres, flakes strands or veneer, is mixed with a bonding agent, such as resin, and compressed and heated to create a finished article. In many cases, the finished article is a board for use in building construction. An example of a composite wood product is oriented strand board (OSB). Other products include particleboard, medium density fibreboard (MDF), Timberstrand™, Parallam™, and strawboard. Under normal manufacturing conditions, composite cellulosic products are highly compacted at high temperature for a short time in press 12, and are glued with as little resin as possible. When exposed to humidity or water, the product tends to swell to a greater extent than lumber due to the compaction process. For example, the thickness swell for OSB is 10-15% compared to only 4-7% for solid wood or plywood. The method and product of the present invention have been developed to provide significantly improved dimensional stability in a composite cellulosic product.

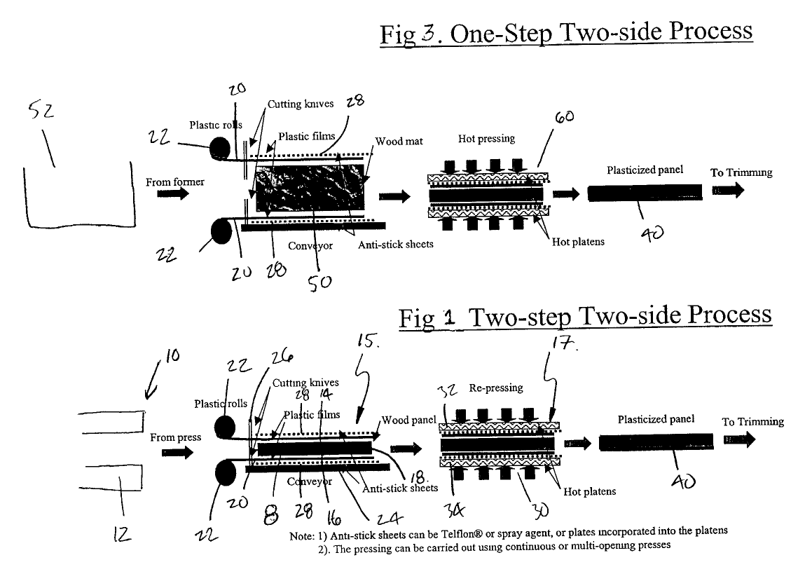

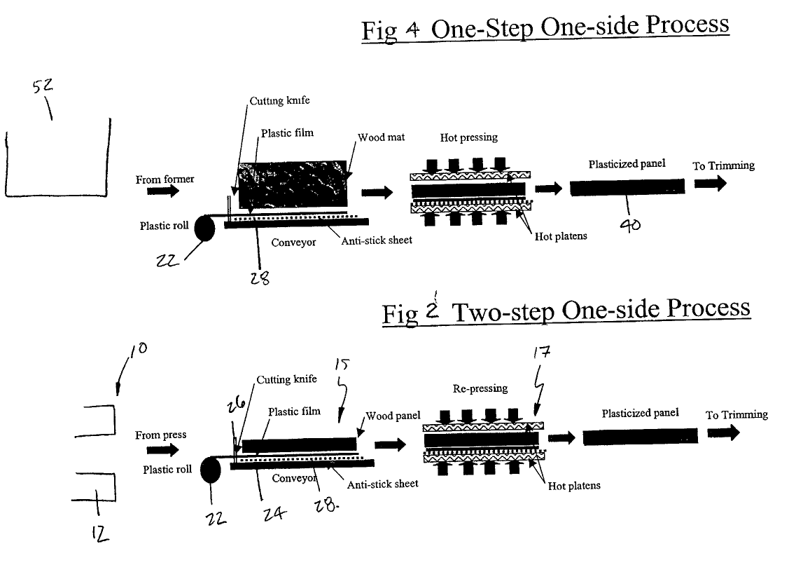

In FIG. 1, as composite cellulosic boards 8 are produced by the conventional manufacturing process, they are delivered to a film application station 15 to apply sheets of thermoplastic material to at least one surface of the board. Board 8 has two large, opposed upper and lower side surfaces 14 and 16 and four edge surfaces 18. In the method illustrated in FIG. 1, thermoplastic material 20 is shown being applied to the larger side surfaces 14 and 16 of the board since these surfaces provide the greatest area for entry of moisture into the board to cause swelling. FIG. 2 illustrates a similar process in which only one side surface of board 8 has thermoplastic material 20 applied. When using a board with only one treated surface, the treated surface will necessarily be oriented to be exposed to any expected moisture.

Thermoplastic material 20 is preferably applied in the form of a thin film plastic sheet. Based on prototype testing, the plastic sheet is preferably greater than about 2 mil (thousandths of an inch) in thickness. Thicker plastic sheets generally result in better performance than thinner plastic sheets. If the sheet is any thinner than about 2 mil, it tends not to be able to seal the side surface of the composite product when heated in place. The thicker the sheet, the less prone it is to tearing during the application process or to nicking or cutting in the finished product. The thermoplastic material is preferably polyethylene or polypropylene, however, any plastic material that has thermoplastic characteristics will do. A thermoplastic material is one that becomes plastic on heating and hardens on cooling, and is able to repeat these processes. In contrast, a thermosetting material is one that sets permanently when heated. Polyester can also be used as a suitable thermoplastic material, however, polypropylene or polyethylene is preferred due to their lower melting temperature and lower cost.

As illustrated in FIGS. 1 and 2, thermoplastic material 20 is preferably applied by providing a rotatable roll 22 adjacent to each surface to which the thermoplastic material is to be applied. The thermoplastic material is stored wound about each roll 22. A conveyor 24 moves board 8 past rolls 22, and each roll 22 is rotated at an angular speed to smoothly deliver the thermoplastic material to cover the surfaces of the board. Once the board is covered, a knife 26 cuts the sheet.

Film application station 15 provides a convenient location to apply a non-stick coating over the thermoplastic layer to prevent sticking of the thermoplastic layer to heated press platens in subsequent steps. The non-stick coating is preferably in the form of a Teflon® sheet 28 applied over the thermoplastic material. Alternatively, the non-stick coating can be sprayed on or incorporated into the platens of the heated press.

After film application station 15, board 8 with thermoplastic film 20 on one or both side surfaces and non-stick coating 28 associated with each film is delivered to heating and pressing station 17. Station 17 is a conventional heated platen press 30 with opposed, movable platens 32 and 34. The platens act to apply pressure and heat for a pre-determined period to melt the thermoplastic film to bond to and coat the side surfaces of board 8. Typically, for polypropylene or polyethylene the pressing temperature will be about 200° C. at a pressure of about 50 psi for about 1 to 5 minutes. The heat must be sufficient to melt the plastic so that the applied pressure forces the molten plastic into the micro-voids on the panel faces. On opening of press 30, the temperature drops and the thermoplastic material hardens into a coat bonded to the side surfaces to substantially seal the side surfaces of board 8. This method differs from a lamination process as it requires no resin and thermoplastic material 20 undergoes a phase change during the process.

After processing at station 17, a plasticized composite cellulosic product 40 with one or more coated side surfaces is produced. The plasticized composite cellulosic board is then subjected to further conventional processing steps such as trimming, stacking and edge sealing. Edge sealing typically involves spraying the edges of the board with a water repellant compound. The resulting composite cellulosic product has a cross-sectional structure as illustrated in detail in FIG. 5 which is not to scale. The cellulosic product has a rigid core layer 44 formed from heated and compressed cellulosic material and bonding agent. There is a thin layer 46 of thermoplastic material melted and pressed onto at least one of the side surfaces of the core layer to coat the surface. In FIG. 5, both side surfaces are coated. Optionally, the edge surfaces can be sealed in an additional step that involves spraying a liquid sealant on the edges.

The method illustrated in FIGS. 1 and 2 is performed as a batch process and press 30 is a batch press. It will be apparent to those skilled in the art that the method of the present invention also finds application when board 8 is produced in a continuous process. In a continuous process, thermoplastic material 20 is applied to the surfaces of the board on a continuous basis. Heating and pressing station 17 employs a continuous press and the finished product with thermoplastic coated surfaces is cut to size as it emerges from the press.

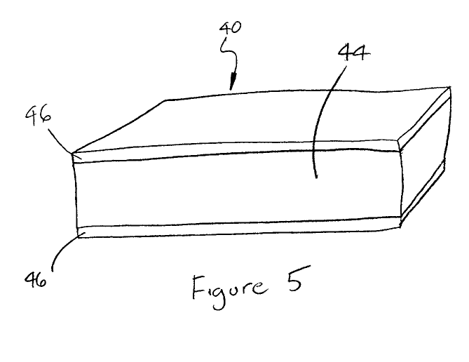

FIGS. 3 and 4 illustrate an alternative method for applying thermoplastic material 20 to the side surfaces of the board. This method involves applying the thermoplastic material during an intermediate step in the manufacture of the composite cellulosic product as opposed to applying the material to a product finished according to the conventional manufacturing process.

In the conventional manufacturing process for a composite cellulosic product, there is a step which involves organizing cellulosic material coated in a bonding agent, such a resin, into a mat in a forming box. The mat is then heated and pressed to create the finished composite product. As illustrated schematically in FIGS. 3 and 4, the step of applying the sheet of thermoplastic material according to the present invention can be carried out on the uncompressed mat 50. In this case, thermoplastic material 20 is applied in the same manner as previously. Preferably, mat 50 is conveyed from forming box 52 on a conveyor 24 past rolls 22 which support a supply of wound thermoplastic material 20. The rolls are rotated to deliver thermoplastic material to one or both side surfaces of the mat. FIG. 3 shows a process in which both surfaces of mat 50 received thermoplastic material and FIG. 4 shows only a single surface being covered. In addition, a non-stick surface 28 is applied over the thermoplastic layer. Uncompressed mat 50 is then advanced to heated platen press 60. Platens 62 and 64 are operated in a conventional manner to simultaneously heat and compress mat 50 and melt thermoplastic layer 20 onto one or both side surfaces of a newly formed composite board 40.

In the process illustrated in FIG. 3 with both side surfaces being coated with the thermoplastic layer, it is necessary to prolong the pressing opening time to allow gas/steam present in the compressed mat to escape from the interior of the product through the edge surfaces. If this is not permitted, gases trapped in the interior of the composite cellulosic product between the thermoplastic layers may cause the board to rupture. In the process illustrated in FIG. 4, in which only one side surfaces is coated with thermoplastic material, increased press opening times are unnecessary as the unsealed surface of the finished product permits ready escape of gases/steam.

The process illustrated in FIGS. 3 and 4 can be performed in a batch mode or on a continuous basis.

The following specific examples will further illustrate the practice and advantages of the present invention:

### EXAMPLE 1

Samples of oriented strand board were produced according to the method illustrated in FIG. 1 with both side surfaces of the finished product having an applied thermoplastic layer. Samples of the plasticized board and a control board were subjected to a 24 hour soaking test in which the samples were completely submerged in water. Table 1 is a summary of the average water absorption rates (% of total weight of dry board) and thickness swell (% increase in original thickness) for the indicated samples.

| | Water absorption | Thickness Swell |
|---|---|---|
| Controls | 24.2% | 11.1% |
| Plasticized (Without | 11.6% | 3.3% |
| edge seal) | | |
| Plasticized (With | 5.1% | 2.2% |
| edge seal) | | |

The results of the soaking test clearly indicate that the method of the present invention produces an OSB board with significantly improved water resistance and dimensional stability. In prototype testing thickness swell reduction was over 70%. Further improvement is gained by combining plasticization with edge sealing.

### EXAMPLE 2

Samples of oriented strand board were produced according to the method illustrated in FIG. 1 with both side surfaces of the finished product having an applied thermoplastic layer. Samples were manufactured using different types and thicknesses of thermoplastic material. The samples were all manufactured using pressing temperature of 200° C. at 50 psi for 3 minutes. Samples of the plasticized boards were subjected to a 24 hour soaking test in which the samples were completely submerged in water. Table 2 is a summary of the average water absorption rates (% of total weight of dry board) and thickness swell (% increase in original thickness) for the indicated samples.

TABLE 2
Effects of different plastics

| | Water absorption | Thickness swell |
|---|---|---|
| Polypropylene (6 | 10.2% | 2.9% |
| mil) | | |
| Polyethylene (6 | 12.8% | 3.6% |
| mil) | | |
| Polyethylene (3 | 13.0% | 4.5% |
| mil) | | |
| Polyester (3 mil) | 13.9% | 4.8% |

While all the thermoplastic films were effective at significantly reducing thickness swell and water absorption, it is apparent that thicker plastic films result in better performance than thinner films. Polypropylene and polyethylene are preferred to polyester because of their lower melting temperature and lower cost.

### EXAMPLE 3

The method of the present invention provides an improved product with superior dimensional stability. At the same time, strength testing of plasticized OSB sample panels and untreated control samples to measure Modulus of Elasticity (MOE), Modulus of Rupture (MOR) and Internal Bond Strength (IB) indicates that the product is equal in strength to conventional OSB. Thus, the process appears to have no negative effect on the strength characteristics of the finished product. Table 3 is a summary of board strength properties. Bending strength in both the parallel (MOE_{∥} and MOR_{∥}) and perpendicular (MOE_{⊥} and MOR_{⊥}) directions.

TABLE 3
Effects of plasticization on board strength
properties

| | MOE_{∥} | MOR_{∥} | MOE⊥ | MOR⊥ | IB |
|---|---|---|---|---|---|
| | (Mpsi) | (psi) | (Mpsi) | (psi) | (psi) |
| Control Boards | 0.851 | 4964 | 0.362 | 3165 | 51.4 |
| Plasticized | 0.893 | 5052 | 0.372 | 2541 | 52.3 |
| Boards | | | | | |

### EXAMPLE 4

The process of the present invention can be carried out as a one-step process in which the thermoplastic material is applied to the mat of cellulosic material and the compressed core layer and thermoplastic layers are formed simultaneously by applying heat and pressure in a press (FIGS. 3 and 4). Alternatively, the process can be carried out in a two step process in which the composite cellulosic panel is produced first and the thermoplastic layers applied subsequently (FIGS. 1 and 2). Samples of plasticized oriented strand board were produced according to the one-step or two-step process. The samples were subjected to a 24 hour soaking test in which the samples were completely submerged in water. Table 4 is a summary of the average water absorption rates (% of total weight of dry board) and thickness swell (% increase in original thickness) for the indicated samples.

TABLE 4
Comparing one-step process with two-step process

| | Water Absorption | Thickness Swell |
|---|---|---|
| One-Step Process | 15.4% | 4.8% |
| Two-Step Process | 11.6% | 3.3% |

Both the one-step and two-step processes provide improved dimensional stability over untreated boards, however, the results indicate that boards produced according to the two-step process offer better dimensional stability.

An additional advantage of the product of the present invention is that the thermoplastic layer or film acts as a barrier between the cellulosic product core and any covering material applied to the product. The thermoplastic layer prevents discolouration of the covering material by preventing the leaching of extractives from the cellulosic composite product. For example, composite panels are often used as sub-flooring and a vinyl floor cover is applied over the panels. The vinyl floor covering can be stained or discoloured if resin extractives leach from the panel. The thermoplastic layers of the panels constructed according to the present invention avoid this problem by sealing the extractives within the interior of the panel.

Although the present invention has been described in some detail by way of example for purposes of clarity and understanding, it will be apparent that certain changes and modifications may be practiced within the scope of the appended claims.

I claim:

1. A method for manufacturing a dimensionally stable composite cellulosic product having side and edge surfaces, comprising the steps of:
applying a sheet of thermoplastic material to at least one surface of the composite product; and
applying pressure and heat for a pre-determined period to melt the thermoplastic material to bond to and coat the at least one surface of the product.

2. A method as claimed in claim 1 in which the step of applying pressure and heat is performed in a press having heated press surfaces.

3. A method as claimed in claim 2 including the additional step of applying a non-stick coating between the heated press surfaces and the thermoplastic material.

4. A method as claimed in claim 2 in which the application of heat and pressure is performed in a continuous press.

5. A method as claimed in claim 2 in which the application of heat and pressure is performed in a batch press.

6. A method as claimed in claim 1 in which the sheet of thermoplastic material is applied to the two opposed side surfaces of the cellulosic composite product.

7. A method as claimed in claim 6 including the additional step of sealing the edge surfaces of the product.

8. A method as claimed in claim 6 in which the step of sealing the edge surfaces of the cellulosic composite product comprises applying a water repellant compound to the edge surfaces.

9. A method as claimed in claim 1 in which the thermoplastic material is a thin sheet of polyethylene.

10. A method as claimed in claim 1 in which the thermoplastic material is a thin sheet of polypropylene.

11. A method as claimed in claim 1 in which the thermoplastic material is a thin sheet of polyester.

12. A method as claimed in claim 1 in which the thermoplastic material has a thickness greater than about 2 mil.

13. A method as claimed in claim 1 in which the step of applying a sheet of thermoplastic material comprises the steps of:
providing a rotatable roll to store the thermoplastic material wound about the roll;
moving the composite cellulosic product past the rotatable roll; and
rotating the rotatable roll at an angular speed to deliver the thermoplastic material to cover the at least one surface of the cellulosic product.

14. A method as claimed in claim 13 including the additional step of cutting the thermoplastic material when the at least one surface is completely covered.

15. The composite cellulosic product produced according to the method of claim 1.

16. A method for improving the dimensional stability of a composite cellulosic product comprising the step of hot pressing a thermoplastic film over at least one surface of the product to coat the surface.

17. A method as claimed in claim 16 in which the step of hot pressing a thermoplastic film is performed on a finished composite cellulosic product.

18. A method as claimed in claim 16 in which the step of hot pressing a thermoplastic film is performed as an intermediate step in the manufacture of the composite cellulosic product.

19. A method as claimed in claim 18 in which the manufacture of the composite cellulosic product involves forming a mat of cellulosic material coated with a bonding agent and applying heat and pressure to the mat, and the step of hot pressing a thermoplastic film comprises applying a film over at least one of the surfaces of the mat and applying heat and pressure to the mat and film simultaneously.

20. In a composite cellulosic product formed from cellulosic material and a bonding agent, the improvement comprising at least one of the surfaces of the product being coated with a sheet of thermoplastic material bonded to the at least one surface by melting and pressing the material to the surface.

21. A composite cellulosic product as claimed in claim 20 in which two opposed surfaces of the product are coated with a sheet of thermoplastic material.

22. A composite cellulosic product as claimed in claim 20 in which the thermoplastic material is a thin sheet of polypropylene.

23. A composite cellulosic product as claimed in claim 20 in which the thermoplastic material is a thin sheet of polyethylene.

24. A composite cellulosic product as claimed in claim 20 in which the thermoplastic material is a thin sheet of polyester.

25. A composite cellulosic product as claimed in claim 20 in which the thermoplastic material has a thickness greater than about 2 mil.

26. A composite cellulosic product comprising:
a core layer of cellulosic material and bonding agent formed by heating and pressure into a rigid, compressed material having side and edge surfaces;
a layer of thermoplastic material melted and pressed onto at least one of the side surfaces of the core layer to bond to and coat the side surface.

27. A composite cellulosic product as claimed in claim 26 in which opposed side surfaces of the core layer are coated with the thermoplastic material.

28. A composite cellulosic product as claimed in claim 26 in which the thermoplastic material is a thin sheet of polypropylene.

29. A composite cellulosic product as claimed in claim 26 in which the thermoplastic material is a thin sheet of polyethylene.

30. A composite cellulosic product as claimed in claim 26 in which the thermoplastic material is a thin sheet of polyester.

31. A composite cellulosic product as claimed in claim 26 in which the thermoplastic material has a thickness greater than about 2 mil.

32. A composite cellulosic product as claimed in claim 26 in which at least one of the edge surfaces of the core layer is sealed with a sealant.

33. A method for manufacturing a dimensionally stable composite cellulosic comprising the steps of:
organizing cellulosic material and a bonding agent into a mat having side and edge surfaces;
applying a sheet of thermoplastic material to at least one surface of the mat; and
applying pressure and heat for a pre-determined period to the mat and thermoplastic material simultaneously to compress and heat the mat into a finished composite cellulosic product having at least one surface bonded to and coated with the thermoplastic material.

34. A method as claimed in claim 33 in which the step of applying pressure and heat is performed in a press having heated press surfaces.

35. A method as claimed in claim 34 including the additional step of applying a non-stick coating between the heated press surfaces and the thermoplastic material.

36. A method as claimed in claim 34 in which the application of heat and pressure is performed in a continuous press.

37. A method as claimed in claim 34 in which the application of heat and pressure is performed in a batch press.

38. A method as claimed in claim 33 in which the sheet of thermoplastic material is applied to two opposed side surfaces of the mat.

39. A method as claimed in claim 33 in which the thermoplastic material is a thin sheet of polyethylene.

40. A method as claimed in claim 33 in which the thermoplastic material is a thin sheet of polypropylene.

41. A method as claimed in claim 33 in which the thermoplastic material is a thin sheet of polyester.

42. A method as claimed in claim 33 in which the thermoplastic material has a thickness greater than about 2 mil.

43. A method as claimed in claim 33 in which the step of applying a sheet of thermoplastic material includes the steps of:
providing a rotatable roll to store the thermoplastic material wound about the roll;
moving the mat past the rotatable roll; and
rotating the rotatable roll at an angular speed to deliver the thermoplastic material to cover the at least one surface of the mat.

44. A method as claimed in claim 43 including the additional step of cutting the thermoplastic material when the at least one surface is completely covered.

45. The composite cellulosic product produced according to the method of claim 33.
